(19) United States
(12) Patent Application Publication
(10) Pub. No.: US 2011/0036683 A1
(43) Pub. Date: Feb. 17, 2011

(54) SYSTEM AND METHOD FOR PACKAGING AN UNDERGARMENT

(76) Inventor: Rebecca G. Cook, Pittsboro, NC (US)

Correspondence Address: BLACK LOWE & GRAHAM, PLLC, 701 FIFTH AVENUE, SUITE 4800, SEATTLE, WA, 98104, US

(21) Appl. No.: 12/865,088

(22) PCT Filed: Jun. 16, 2009
(86) PCT No.: PCT/US09/47523

§ 371 Date: Oct. 20, 2010

Related U.S. Application Data
(60) Provisional application No. 61/073,302, filed on Jun. 17, 2008.

(51) Int. Cl. G07F 7/08; B65B 31/02; B65D 83/00; G07F 11/00

(52) U.S. Cl. 194/210; 53/405; 221/69

(57) ABSTRACT

The present invention includes a system and method for packaging an undergarment that as a result of the packaging, the undergarment requires a substantially small amount of storage space that can be carried discretely on ones person during active times, and/or easily purchased when out on the go. The undergarment packaging system packages the undergarment so that it consumes a relatively small amount of space so that it can be easily and conveniently sold and/or vended to consumers in locations where they would most need them, for example in restrooms, gyms, spas, glove-compartments in cars, in airports, and the like.

### PRIORITY CLAIM

This application claims priority to U.S. Provisional Patent Application Ser. No. 61/073,302 filed Jun. 17, 2008, which application is hereby incorporated in its entirety.

### FIELD OF THE INVENTION

The present invention relates generally to packaged and sizably compressed undergarments. More particularly, the present invention relates to substantially size-reduced, vacuum-packaged and/or shrink-wrapped undergarments for adults and children.

### BACKGROUND OF THE INVENTION

Undergarments are generally a necessity for everyone. With the increase in our daily activities outside of the home, e.g. working out in a gym, partaking in spa activities, doctor's appointments, school, hiking, biking, rock climbing, traveling necessitate our distance and time spent away from home, a change of clothes as we move between activities is almost a daily occurrence. A change of clothes is often precipitated by these activities particularly when physical exercise is engaged in, for example after an energetic and sweaty work-out. In addition there are occasions when more discretion is desired than is provided, for example those irritatingly small hospital gowns that leave one feeling exposed, a smaller than usual towel during a massage, a doctor's appointment, in emergency rooms, or even trying on underwear/swimsuits in a large department store. Also, inevitably, there are also those occasions that an individual may need a fresh change of clothes because their undergarments have become soiled, or the individual feels less than fresh. For example, young toddlers and older individuals incapable of controlling the release of bodily waste in a manner sufficiently reliable to enable the use of restroom facilities are often in need of a clean pair of undergarments when theirs become soiled. Also unexpected menstruation is a soiling issue for women of all ages, even the best prepared. Also, stranded travelers are often left feeling less comfortable because of lost luggage and unplanned travel delays. Natural disasters and other emergences often leave their victims without anything, let alone a clean change of clothes. Additionally, it is an undeniable fact of life that college students, and other really busy people are less apt to do laundry in a timely manner due to hectic schedules.

Individuals don't often carry spare, clean undergarments because they are an afterthought, they are often forgotten, unplanned lost luggage, or they are just inconvenient and bulky to carry around, or even potentially embarrassing to carry around. Storage and carriage of clean undergarments is often inconvenient, not to mention those unplanned events. Moreover, undergarments are personal items and are generally not given to easy and discrete storage or carriage in a purse, pocket, or otherwise about the person. Campers and frequent travelers often bemoan the fact that not all the stuff they need fits in the limited space in their luggage and/or backpacks. With increased costs imposed by airlines for checked luggage, more travelers will only be taking carry-on luggage, needing to make the best use of their limited available/allocated space.

While many products are directed to incontinence due to immaturity and/or absorption of bodily fluids due to old age, age-related pregnancy or post-childbirth incontinence, there is a need in the market place for convenient, discretely packaged regular undergarments that are substantially size-reduced for ease of packing and carrying.

### SUMMARY OF THE INVENTION

It has been recognized that it would be advantageous to develop a packaged undergarment that requires a substantially small amount of storage space that can be carried discretely on ones' person during active times, and/or easily purchased when out on the go.

In addition, it has been recognized that it would be advantageous to develop an undergarment packaging system that consumes a relatively small amount of space so that it can be easily and conveniently sold and/or vended to consumers in locations where they would most need them, for example in restrooms, gyms, spas, glove-compartments in cars, in airports, and the like. Basically, wherever one is on the go.

The invention provides a packaged undergarment, including an undergarment, having a first, actual size when fully expanded, and a second, substantially reduced size, the reduced size of the undergarment being convenient for carriage and storage of the undergarment. An encasement can be provided, in which the undergarment can be contained in the second, substantially reduced size. The encasement can confine the undergarment so that the undergarment is retained in its substantially reduced size by the encasement and so that the undergarment is returned to its actual size upon opening of the encasement.

In accordance with another aspect of the invention, a packaged undergarment is provided, including an undergarment, having a first, folded configuration characterized by a nominal length, width and height, and a second, reduced-sachet configuration characterized by a second, reduced length, width and height. The reduced length can be between less than 20-80% of the actual length, the reduced width can be between about less than 20-80% of the actual width, and the reduced thickness can be less than between 20-80% of the actual thickness.

In accordance with another aspect of the invention, a packaged undergarment is provided, including an undergarment, having a first, nominal size and shape, and a reduced, substantially pod-like in size and shape. The reduced, substantially cylindrical shape can have a diameter less than 20-80% of the actual diameter; the reduced length can be between about less than 20-80% of the actual length.

In accordance with another aspect of the invention, a method of packaging an undergarment is provided and includes the steps of: enclosing the folded undergarment within an encasement comprised of a substantially air impermeable material; evacuating air from the encasement and the folded undergarment; and sealing the encasement to maintain a vacuum created within the encasement and the folded undergarment.

In accordance with another aspect of the invention, a method of packaging an undergarment is provided and includes the steps of: pulling an undergarment into a moldable encasement; enclosing the undergarment within a moldable encasement comprised of a substantially air impermeable material; evacuating air from the moldable encasement and the undergarment; and sealing the moldable encasement to maintain a vacuum created within the moldable encasement and the undergarment and to maintain the desired moldable shape of the encasement.

In accordance with another aspect of the invention, a method of packaging an undergarment is provided and includes the steps of: wrapping an undergarment into a moldable encasement; enclosing the undergarment within the moldable encasement comprised of a substantially air impermeable material thereby compressing the moldable encasement and the undergarment; and substantially sealing the moldable encasement to maintain the sizably-reduced configuration of the moldable encasement and the undergarment thus maintaining the desired moldable, sizably-reduced shape of the encasement.

In accordance with another aspect of the invention, the encasement and the undergarment and possibly the encasement are made of essentially all bio-degradable and all natural products. In one non-limiting embodiment the encasement and/or undergarment can be made of soybean, hemp, and/or cotton. Alternatively, the encasement and/or undergarment can be made of all recycled materials, and/or is fully recyclable.

To enhance the user experience of the undergarment a fragrance or scent can be infused in a scent sachet contained within the vacuum-sealed and/or sizably compressed encasement with the undergarment such that the scent is locked therein until the undergarment is unpackaged and/or the vacuum seal is broken. Alternatively, the encasement and/or the undergarment itself can contain fibers impregnated with a fragrance. In an exemplary embodiment, a fiber composed of an active agent/positive dispensing carrier combination and a fiber forming component can be used, as is known in the art. As a fiber or non-woven or textile fabric containing the fiber, an agent can deliver the active agent at a desired rate under conditions of use. Other active agents that can be dispensed include skin wellness agents, therapeutic agents, and cleaning agents, for example.

In accordance with the another aspect of the invention, the undergarment is made in a variety of configurations, for example, boxer, brief, thong, bikini, cheekies, hip-hugger, v-string, boy-short, maternity and the like, which may be dependent on the user and the situation.

In accordance with another aspect of the invention, a method of packaging an undergarment is provided and includes the encasement being contained within additional outer packaging. In an exemplary embodiment, a pod-shaped encasement may be suitable for fitting in within cylindrical outer containers to attach to carabineers or key chain. Alternatively, a sachet encasement may be suitable for vended products in a box-like container.

In accordance with another aspect of the invention, an undergarment changing kit is provided and includes a packaged undergarment in accordance with one or more previously set forth aspects of the invention, at least one freshening sachet, and a container in which the packaged freshening sachet and the freshening sachet can be disposed. In a more detailed aspect, the accessory can be one or more of: a scented sachet and/or a disposal bag for a soiled undergarment to be discreetly disposed of after being removed.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

Preferred and alternative examples of the present invention are described in detail below with reference to the following drawings:

FIG. 1-1 is a top view of an exemplary embodiment of an undergarment in an actual-size configuration;

FIG. 1-2 is a top view of a undergarment within an encasement in a substantially-size reduced sachet-configuration in accordance with an embodiment of the present invention;

FIG. 1-3 is a perspective view of the undergarment of FIG. 1-2 being disposed within an box-shaped outer package;

FIG. 1-4 is a top view of a undergarment in an encasement in a substantially-size reduced pod-configuration in accordance with an embodiment of the present invention;

FIG. 1-5 is a perspective view of the undergarment of FIG. 1-4 being disposed within an cylindrical outer package;

FIG. 2 is a flowchart of an exemplary embodiment of the method of the instant invention; and

FIG. 3 is a flowchart of an exemplary embodiment of the method of the instant invention.

### DETAILED DESCRIPTION OF THE PREFERRED EMBODIMENT

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one, skilled in the relevant art and having possession of this disclosure, are to be considered within the scope of the invention.

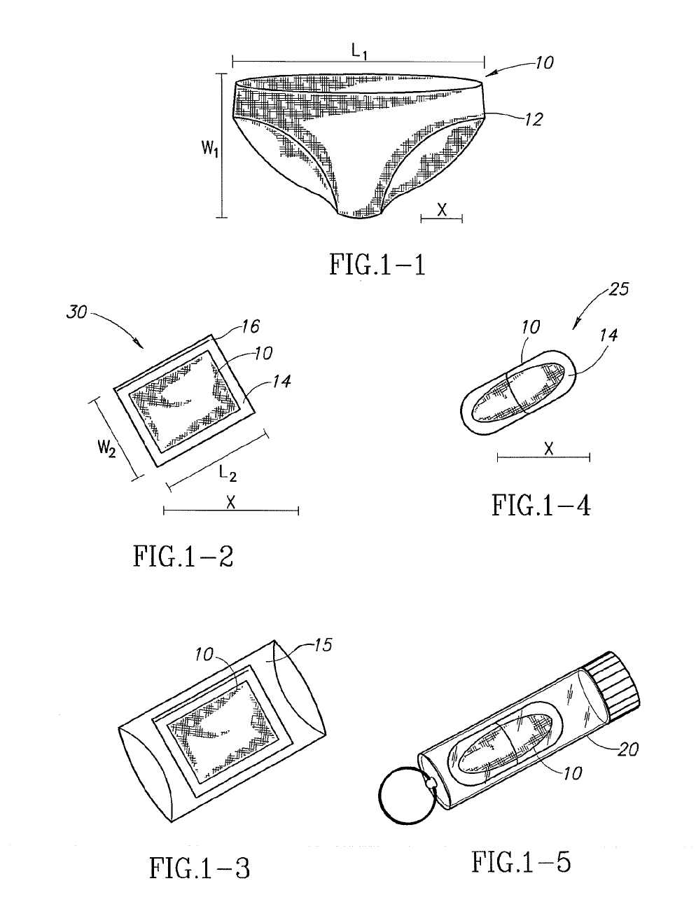

As illustrated in FIGS. 1-1 through 1-5, an exemplary packaged, undergarment 10 is sized and shaped to consume a substantially smaller space and be more conveniently shaped for discrete purchase and carrying on ones person. As illustrated, the packaged undergarment 10 begins as an actual sized undergarment 12 (FIG. 1-1) sized and shaped in accordance with conventional configurations, but made of sufficiently stretchy and/or compressible material. In one non-limiting embodiment, for example the undergarment may be constructed such that one size fits all. The undergarment can be made of a variety of materials including all natural material such as soy, cotton, hemp, bamboo, and the like, or other man-made materials such as Lycra®, nylon, and the like. The undergarment can be disposable and/or non-disposable (i.e., reusable). Preferably, the natural materials would be used to facilitate bio-degradability, and/or disposability. Furthermore, they can be formed in a variety of styles, for example standard boxers, briefs, bikinis, thongs, cheekies, hip-huggers, hi-cut legs, boy-shorts, maternity and the like.

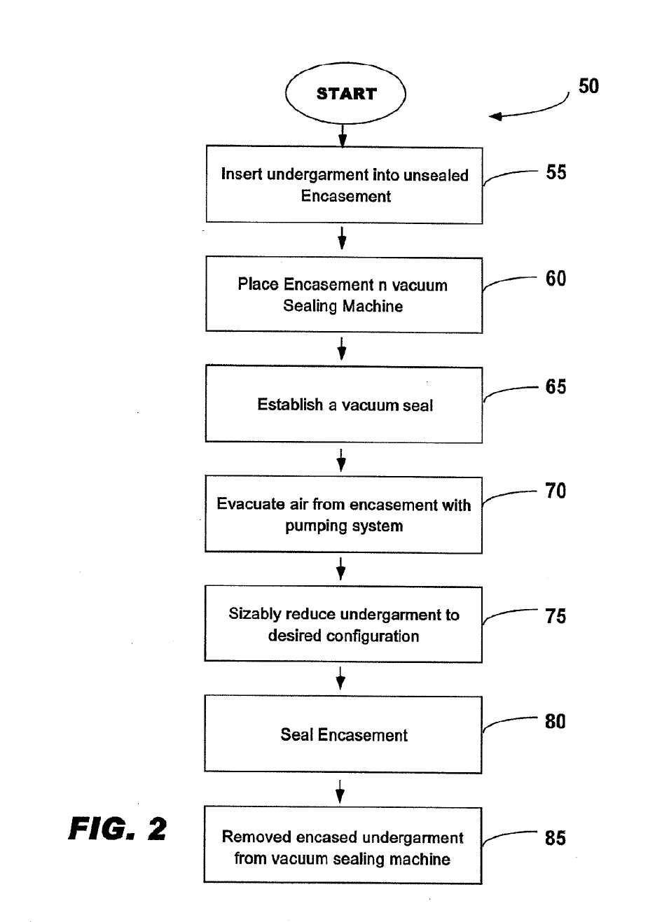

As shown in FIG. 1-2, an example of a packaged undergarment 10, includes an undergarment 12 having a substantially size-reduced configuration characterized by a reduced length L₂ and width W₂ of the undergarment 12. Thus, the undergarment, by application of a vacuum, and/or compression can be reduced in volumetric configuration to consume much less space.

The undergarment 12 can be disposed in an encasement 14 that can be formed of a substantially air impermeable material. By containing the undergarment in the encasement in the second, reduced volumetric configuration, a packaged undergarment is provided that consumes much less space than when in its actual, pre-vacuum and/or pre-compression configuration. By “substantially air impermeable,” what is meant is that the permeability is low enough that the packaging maintains its vacuum-packaged and or compressed configuration.

In a series of experiments conducted by the Applicant, it has been found that by drawing a vacuum with a residential vacuum forming apparatus, at a location about 1300 feet elevation above mean sea level, the size of the undergarment can be reduced to as little as 20% of the actual-pre vacuum size. The reduction in size of packaged undergarments is not only advantageous in reducing storage space, but is also advantageous for the discrete carrying of the undergarments. For example the reduced size makes it possible to carry changes of undergarments in a pocket, purse, briefcase, gym bag, lip-stick case, and the like.

In another series of experiments conducted by the Applicant, it has been found that compression and shrink wrapping can also significantly reduce the size of the undergarment, reducing to as little as 20% of the actual-pre vacuum size, depending upon the style and material of the undergarment.

In FIGS. 1-2 and 1-4, the packaged undergarment 10 includes the encasement 14. Once the undergarment 12 is placed within the encasement 14, the encasement 14 can be evacuated of air so as to contain the undergarment 12 in a vacuum state. The degree to which the size is reduced by the application of the vacuum can depend on default (e.g. compressibility of the material) or by design. For example how far reduced the undergarment 12 becomes may depend on the final outer packaging desired, for example, a sachet-shaped or a pod-shaped encasement can be required. The pod-shaped encasement 25 (See FIGS. 1-4 and 1-5) can be configured to fit within a lip-stick sized cylinder 20. Or, a sachet shaped oval or rectangular shaped encasement 30 can be used to fit within a box approximately the size of a conventionally configured cigarette box 15.

The evacuation of air from within the undergarment and encasement can be done in a number of ways, such as by conventional vacuum-packing methods. For example, according to at least one exemplary vacuum-packing method for packaging an undergarment (See FIG. 2, 50), vacuum-packing can proceed according to the following steps. First, at a BLOCK 55, an article to be vacuum-packed is inserted into an unsealed encasement formed of an air impermeable flexible material. Next, at a BLOCK 60, the unsealed encasement with the item to be sealed within is placed onto the deck of a vacuum-sealing machine. The lid of the vacuum-sealing machine is then lowered establishing a seal with the deck and to define a chamber between the deck and the lid with the unsealed encased article within the chamber 65. A pumping system evacuates the ambient air from the chamber creating at least a partial vacuum state within the chamber and within the interior space of the unsealed encasement with the article therein, thus sizably reducing the undergarment therein 75. Sealing bars then seal the encasement to maintain at least a partial vacuum state therein 80. Ambient air pressure is then restored to the chamber affecting a pressure differential across the sealed encasement. Insofar as the item within the sealed flexible encasement is compressible, the pressure differential acts upon the encasement to compress the item and maintains the item in a reduced volume that is less than the volume of the item at the time the encasement was sealed (before ambient air pressure was restored to the chamber). The lid of the machine is then raised and the vacuum-packed article is available for removal from the machine 85.

One or more embodiments of the invention relate to a method of packaging an undergarment using a conventional vacuum-sealing machine as discussed above. As is described here, a small residential model of the SealAMeal machine was used, but it is to be understood, that commercial applications are available, whose mode of operation is substantially similar. The salient features of the above method 50 being the sealing of the undergarment in an encasement as shown in FIGS. 1-2 and 1-4 such that the interior space of the substantially air impermeable encasement is sealed and such that the undergarment 10 is completely enclosed within the sealed interior space. The vacuum acts to compress the undergarment 10 and the seal maintains the undergarment 10 in that sizably-reduced configuration (FIGS. 1-2 and 1-4) that is substantially less than the actual size of the undergarment 12 prior to the application of the vacuum and the ensuing encasement (FIG. 1-1). While the encasement is shown in FIG. 1-2 is sealed at an edge portion 16, it will be understood that the encasement 14 can be sealed in a variety of ways in a variety of locations.

As the encasement 14 configured to confine the undergarment 10 is unpackaged and the vacuum seal is broken, the undergarment returns to its actual-size configuration 12. That is, the user can cut, tear, remove a portion of the encasement, or otherwise break the airtight seal of the encasement 14; after which, the undergarment 10 will no longer be subject to confining force due to the encasement and/or a pressure differential.

The encasement 14 can include a means to facilitate opening, such as a notch, perforation, or another intentionally formed discontinuity (not shown) provided in the encasement to aid in opening the encasement. In one embodiment a tear-away band, or the like, provided with a grasping tab (not shown) can be provided to facilitate opening by rupturing the encasement as it is pulled away there from. One of many other well known ways to provide a more easily broken-open encasement can be used to facilitate opening the packaging.

Depending on the material used for the encasement 14, and the style, and stretch-ability of the undergarment contained therein, an average sized undergarment can be reduced in size by greater than 80%, and can conform to likewise shaped and sized outer-packaging e.g. a pod-like shape to fit within a lip-stick sized container attached to a key ring FIG. 1-5. Because of the significantly reduced size achieved by vacuum packaging the undergarment, it can be easily carried, handled and stored within a purse, pocket, bag or other small, discrete place for ease of portability.

Also, packaged as above, the undergarment 10 enclosed within in the encasement 14 can easily conform to fit within small-boxed, or otherwise shaped packages, and thereby conveniently vended within vending machines as is known in the art.

In accordance with another aspect of the invention, a method of packaging an undergarment is provided and includes the steps of: pulling and/or pushing an undergarment into a moldable encasement; enclosing the undergarment within a moldable encasement comprised of a substantially air impermeable material; evacuating and/or pushing air from the moldable encasement and the undergarment; and sealing the moldable encasement to maintain the moldable encasement and the undergarment in a user-determined moldable shape of the encasement. This embodiment of the invention relates to a method of packaging an undergarment utilizing an adaptation of a vacuum-sealing machine as discussed above and/or compressing and/or shrink wrapping machine.

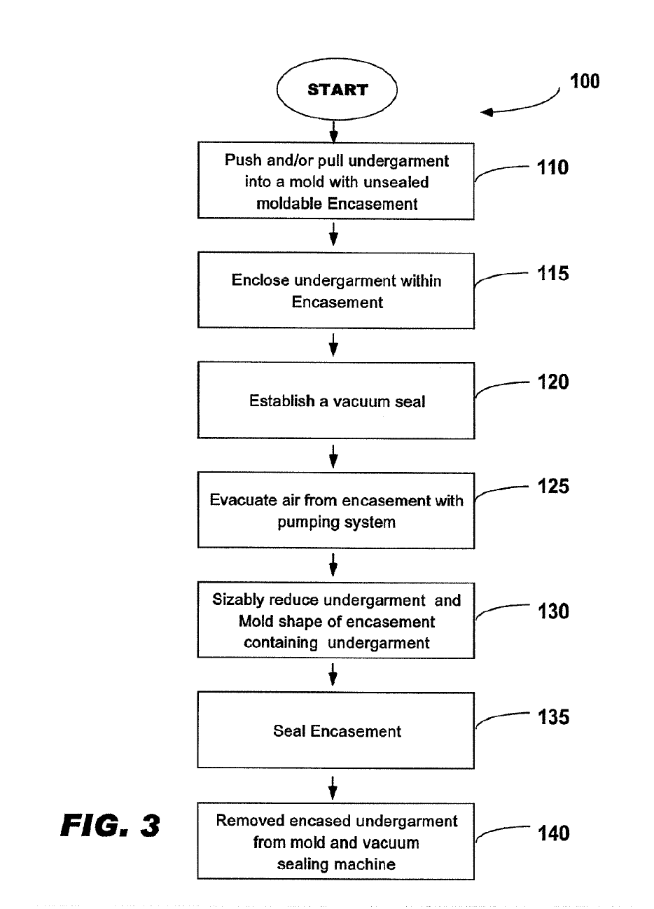

As is described in the exemplary method 100 in FIG. 3, at a BLOCK 110, an undergarment 12 is pushed and/or pulled into a molding chamber containing the encasement 14. In an exemplary embodiment, the undergarment 12 is enclosed within the encasement within the mold 115, and adopts a compacted shape when pushed and/or pulled into the molding space that is then further compressed by either evacuation of the air from the open, unsealed end of a substantially air-impermeable encasement 14 and/or compression by application of pressure 120. In an exemplary embodiment in which a vacuum is used, a seal can be established at an end of the molding chamber and the unsealed encased undergarment within the chamber, both ends being at substantially the same location. That is, the molding chamber is oriented in order to accommodate the application of a sealing mechanism at a position co-localized with a sealable side of the encasement prior to application of a vacuum. At a BLOCK 125, a pumping system then evacuates ambient air from the chamber creating a vacuum state within the chamber and within the interior space defined by the encasement 14 with the undergarment 10 therein (See FIGS. 1-2 and 1-4). The air is evacuated in such a way that the encasement 14 containing the undergarment conforms to the shape of the molding chamber 130. At a BLOCK 135, the sealing mechanism then seals the encasement 14 such that the interior space of the substantially air impermeable encasement 14 is sealed and such that the undergarment 10 is enclosed within the sealed and molded interior space. The sealed encasement 14 acts upon the undergarment 10 to compress the undergarment 10 and maintain the undergarment 10 in a size-reduced configuration (See FIGS. 1-2 and 1-4) that is substantially less than the actual size of the undergarment 12 prior to the application of the vacuum and the ensuing encasement. The encasement 14 is released from the molding chamber and the vacuum-packed undergarment 25, 30 is available for removal from the machine 140. While the encasement 14 as described as sealed at one edge portion (e.g. FIG. 1-2, 16) it will be understood that the encasement can be sealed in a variety of ways in a variety of locations which can be dependent on the final moldable shape of the encased undergarment.

In accordance with another aspect of the invention, the above method of packaging an undergarment 100 can include the steps of: wrapping an undergarment into a moldable encasement; enclosing the undergarment within the moldable encasement comprised of a substantially air impermeable material; and applying pressure to compress the moldable encasement and the undergarment; and substantially sealing the moldable encasement to maintain the sizably-reduced configuration of the moldable encasement and the undergarment thus maintaining the desired moldable, sizably-reduced shape of the encasement. As detailed above in method 100, the undergarment can be pulled and/or pushed into the packaging, but instead of relying on the application of a vacuum, the undergarment within the encasement is compressed into the desired sizably-reduced shape.

It is to be understood that the above referenced arrangements are illustrative of the application for the principles of the present invention. It will be apparent to those of ordinary skill in the art that numerous modifications can be made without departing from the principles and concepts of the invention as set forth in the claims.

While the preferred embodiment of the invention has been illustrated and described, as noted above, many changes can be made without departing from the spirit and scope of the invention. For example, the term “undergarment” is meant inclusively in reference to all manner of wear that is worn under outer garments, that can include categories such as bras, camisoles, pantyhose, stockings, socks, and the like; different materials can be used for the undergarment, the encasement, and the outer packaging; different vacummization methods can be employed to reduce the final size and shape of the undergarment; different compression methods can be employed to reduce the final size and shape of the undergarment; the final sizably-reduced configuration and size can vary depending on the final configuration and conformation desired in the final packaged product; and varying final points of sale are contemplated and thus not dependent on the items being sold by vending. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of packaging an undergarment comprising the steps of:
placing a compressible undergarment within a flexible substantially air impermeable encasement;
creating a vacuum within an interior space defined by the encasement; and
sealing the encasement such that, the interior space of the substantially air impermeable encasement is sealed, and the undergarment is enclosed within the sealed interior space.

2. The method according to claim 1, wherein the packaged undergarment includes a configuration that is different from its actual size by a factor of at least two-fold.

3. The method according to claim 1, wherein the packaged undergarment includes a configuration that is different from its actual size by a factor of at least five-fold.

4. The method according to claim 1, wherein the packaged undergarment includes a configuration that is different from its actual size by a factor of at least ten-fold.

5. The method according to claim 1, wherein the substantially air impermeable encasement is made of bio-degradable material, fully recycled material or recyclable material.

6. The method according to claim 1, wherein the compressible undergarment in the substantially air impermeable encasement made of an all-natural biodegradable material, fully recycled material, or recyclable material.

7. The method according to claim 1, wherein the substantially air impermeable encasement further includes infusing a scent, wherein the vacuum process substantially maintains the scent within the substantially air impermeable encasement.

8. The method according to claim 1, wherein the substantially air impermeable encasement further comprises molding the undergarment into a substantially rectangular-shape.

9. The method according to claim 1, wherein the substantially air impermeable encasement further comprises molding the undergarment into a substantially pod-shape.

10. The method according to claim 1, wherein the substantially air impermeable encasement is further contained within an outer packaging cover, which can contain at least one undergarment contained in a substantially rectangular-shape.

11. The method according to claim 1, wherein the air impermeable encasement is further contained within an outer packaging cover, which can contain within at least one undergarment contained in a substantially pod-shape.

12. A method of packaging an undergarment in a moldable encasement comprising the steps of:
forcing an undergarment into a moldable encasement;
enclosing the undergarment within the moldable encasement comprised of a substantially air impermeable material;
evacuating air from the moldable encasement and the undergarment wherein the moldable encasement adopts a desired molded shape; and
sealing the moldable encasement to maintain a vacuum created within the moldable encasement and the undergarment and to maintain the desired moldable shape of the encasement.

13. The method according to claim 12, wherein the packaged undergarment is in moldable configuration within the moldable encasement that is different from its actual size by a factor of at least two-fold.

14. The method according to claim 12, wherein the packaged undergarment is in a moldable configuration within the moldable encasement that is different from its actual size by a factor of at least five-fold.

15. The method according to claim 12, wherein the packaged undergarment is in a moldable configuration within the moldable encasement that is different from its actual size by a factor of at least ten-fold.

16. The method according to claim 12, wherein the moldable encasement is made of bio-degradable material, fully recyclable, or recycled material.

17. The method according to claim 12, wherein the moldable encasement is substantially air impermeable and further comprises an infused scent, wherein the vacuum process substantially maintains the scent within the moldable encasement.

18. The method according to claim 12, wherein the packaging steps further comprise molding the undergarment into a substantially rectangular-shape.

19. The method according to claim 12, wherein the packaging steps further comprise molding the undergarment into a substantially pod-shape.

20. The method according to claim 12, wherein at least one moldable encasement containing at least one undergarment molded in a substantially rectangular-shape is further contained within an outer packaging cover.

21. The method according to claim 12, wherein at least one moldable encasement containing at least one undergarment molded in a substantially pod-shape is further contained within an outer packaging cover.

22. A vending machine for dispensing a packaged, vacuum-compressed undergarment, comprising:
at least one compartment for storing the packaged, vacuum-compressed undergarments for individual dispensing in response to selection by a consumer; and
a plurality of packaged, vacuum-compressed undergarments disposed within the at least one compartment for individually dispensing to consumers; wherein each of the plurality of packaged, vacuum-compressed undergarments disposed within the at least one compartment includes therein a substantially-size reduced undergarment, a size of the undergarment contained therein being substantially smaller than a size of the undergarment when not vacuum packaged.

23. The vending machine of claim 22, wherein the vacuum-compressed undergarment contained within the vending machine comprises vacuum-packed undergarments in a plurality of styles and configurations.

24. The vending machine of claim 22, wherein the vacuum compressed undergarment contained within the vending machine is packaged in a cigarette box-sized rectangular box.

25. The vending machine of claim 22, wherein the vacuum compressed undergarment contained within the vending machine is packaged in a multi-pack arrangement wherein at least two vacuum compressed undergarments are packaged within the same outer packaging but as individual encased units.

26. An arrangement at a commercial establishment for facilitating purchase of a vacuum-compressed undergarment comprising: a vending machine mounted on the wall for dispensing a vacuum-compressed undergarment, the vending machine comprising:
at least one compartment for storing products for individual dispensing in response to selection by a consumer;
a plurality of products disposed within the at least one compartment for individually dispensing to consumers, wherein each of the plurality of products disposed within the at least one compartments includes therein a vacuum-packed undergarment.

27. The arrangement of claim 26, wherein the wall on which the vending machine is mounted comprises a wall of a public restroom, changing room, dressing room, or locker room of the commercial establishment.

28. The arrangement of claim 26, wherein the vending machine is configured to take cash, change, tokens, and credit/debit cards in exchange for dispensing at least one vacuum compressed undergarment in response to a consumer selection.
